(19) United States
(12) Patent Application Publication
(10) Pub. No.: US 2007/0130607 A1
(43) Pub. Date: Jun. 7, 2007

(54) Method of enabling the programming of a universal remote control system

(75) Inventors: Rogier Louis Jacques Willem Thissen, Leuven (BE); Rudy Musschebroeck, Leuven (BE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC, N.V., EINDHOVEN (NL)

(21) Appl. No.: 10/596,081

(22) PCT Filed: Dec. 2, 2004
(86) PCT No.: PCT/IB04/52642

§ 371 Date: May 30, 2006

(30) Foreign Application Priority Data
Dec. 3, 2003 (EP) 03104513.1

(51) Int. Cl. H04N 7/16; G06F 3/00; G06F 13/00; H04N 7/173; H04N 5/445

(52) U.S. Cl. 725/132; 725/140; 725/152; 725/50

(57) ABSTRACT

A method of enabling the programming of universal remote control system for controlling a CE device of a combination type providing a combination of functionalities equivalent to that provided by a combination of devices with respective basic features, the CE device including an interface for receiving remote control signals to access the combination of functionalities, wherein the combination of functionalities determines possible operational states of the CE device, includes providing input data for a configuration process for generating program code enabling the remote control system to provide remote control signals controlling transitions between the possible states. The input data is assembled by a data processing system in accordance with information defining the combination of devices with basic features received through an interface to the data processing system.

### FIELD OF THE INVENTION

The invention relates to a method of enabling the programming of a control system for controlling a consumer electronics (CE) device of a combination type providing a combination of functionalities equivalent to that provided by a further combination of respective further devices with respective basic features. The CE device includes an interface for receiving a control signal to access the combination of functionalities. The combination of functionalities determines possible operational states of the CE device in operational use. The method includes providing input data for a configuration process for generating program code enabling the control system to provide a control signal controlling a transition between relevant ones of the possible states.

The invention further relates to a control system for controlling a CE device of a combination type providing a combination of functionalities equivalent to that provided by a combination of respective further devices with respective basic features. The CE device includes an interface for receiving a control signal to access the combination of the functionalities. The combination of functionalities determines possible states of the CE device in operational use. The control system is configured to run a set-up process for configuring the control system to provide a control signal controlling a transition between relevant ones of the possible states.

The invention further relates to a data processing system including a processor, memory and an external interface, and to a computer program.

### BACKGROUND ART

A set-up procedure lets users set up all CE devices they have in their house. A control device, e.g., a remote control device, will then be configured to work with those devices. When a user selects a device-type he has (e.g., Television set, Video Recorder, Digital Versatile Disk player, Home Cinema, Personal Computer, etc.), he is able to choose from a prioritized list of models falling within the category indicated by the device-type.

A disadvantage of the known remote control is that it is not well suited to configuration of the remote control to work with a so-called combination device, referred to herein as “combo-device”. A combo-device provides a combination of functionalities equivalent to that provided by a combination of CE devices with basic features. The combo-device can be a single physical entity or a combination of physical entities (“boxes”) in a distributed system such as a home network.

As the range of combinations expands, the definition of what features a combo-device of a certain type actually provides gets fuzy. Accordingly, the remote control must include a very long list of all possible combo-devices as brought on the market by the various manufacturers. With each device, the appropriate input data must be on hand in the remote control for configuring the remote control to control the transitions between the various possible operating states of the combo-device. This requires a remote control with a relatively large amount of memory and an elaborate user interface. Where this is not the case, the combo-device type defined in the remote control may not be adequate to configure the remote control to control all features of a specific combo-device.

### SUMMARY OF THE INVENTION

It is one of the objects of the invention to provide a method, data processing system, control system and computer program that allow the control system to be configured to control the full range of functionalities provided by a device of any particular type within a relatively large range of different combination device types.

A method according to the invention is characterized in that the input data is assembled by a data processing system in accordance with information defining the combination of devices with basic features received through an interface to the data processing system.

The combination device type provides a combination of functionalities equivalent to that provided by a combination of devices with basic features. The processing system receives information defining such an equivalent combination of devices. As a result the processing system need only have access to input data for a configuration process for each of the basic devices. The step of assembling the input data for a process to configure a device of the combination type will simply involve retrieving and processing the input data for each of the basic device types into an appropriate combination of input data There is no need to store a complete set of input data for every combination device type that could possibly be conceived. This saves storage space, as well as allowing a simpler interface. Because a processing device assembles the input data, even complicated combination devices can be configured, without the risk of human error resulting in an inconsistent set of input data for the configuration process.

An embodiment of the method includes receiving a command selecting one of a custom combination device type and at least one pre-defined device type, wherein the input data is assembled upon receiving a command selecting the custom combination device type. If a pre-defined device type is selected, a complete set of input data associated with the selected pre-defined device type is retrieved from a data storage system and provided as input data for the configuration process. Thus, faster operation is achieved in cases where a device of a commonly found type is to be configured. The ability is retained to configure the control system (e.g., the remote control system) to control the full range of functionalities provided by a device of a particular type that is less common.

In an embodiment of the invention, the input data for the configuration process includes a set of (remote) control commands for association with (remote) control codes in a format interpretable by the CE device. In the step of assembling the input data, a (remote) control command, directed at one or more basic features included in a plurality of devices in the defined combination, is included in the set of (remote) control commands only once. Thus, the configuration process can be carried out more efficiently, since the program code does not include duplicate information. Furthermore, this embodiment reduces the chance that the (remote) control system responds to a particular user command by sending the CE device a particular control code twice.

In a further embodiment the input data includes at least a definition of a state variable for tracking the state of the CE device. In the step of assembling the input data, at least one state variable is included corresponding to a state variable for tracking the state of a specific one of the further devices with basic features in the defined combination. Upon determining that a state of a feature in a first one of the further devices in the defined combination is linked to a state of a feature in at least another of the further devices in the defined combination, only one corresponding state variable is included in the input data. This feature of the method is useful in case the (remote) control system has some advanced features based on the tracking of the state of the CE device. In such control systems, the state information is used to conditionally send commands, for example depending on the power state of the CE device. The CE device includes an interface for receiving control commands to access all its functionalities. Components providing the features of basic devices are not controlled through separate user commands, as would be the case in a home network of basic devices. It is thus important for the (remote) control system to derive the consequences of a certain command for the states of all components of the CE device. In this embodiment of the invention, this is achieved in an efficient way by using a shared state variable for features of which the states are coupled.

A further embodiment includes assembling data for generating a graphical user interface on the (remote) control system from respective constituent sets of data defining a graphical user interface for each of a plurality of the further devices in the defined combination. At least one screen view is defined in the assembled data including elements defined in different ones of constituent sets of data. This results in a more compact graphical user interface with fewer screen views, reducing the resources required of the (remote) control system.

In a further variant duplicate elements in the constituent sets of data are subtracted from the defined screen view. Thus, the chances of the user accidentally issuing the wrong commands are reduced. The functionalities, accessible by means of the duplicate elements through associations defined in the constituent sets, are linked to the one element retained in the defined screen view by means of corresponding associations in the assembled data. Thus, a simpler interface provides the full range of effects associated with the element.

In a further embodiment, the information defining the combination of the further devices with basic features is received as user input through a user interface. This embodiment has the advantage that the processing system need not communicate directly with a particular CE device of the combination device type in some specially defined protocol. It is especially useful when the combination device type is embodied in a CE device of a relatively obscure make and/or model, since a configuration process based only on information identifying the make and model is generally not possible in that case.

In a further embodiment, the assembled input data is added as an entry into a database. This has the advantage that the definition need be received and processed only once. It is then usable to program the (remote) control system to control a number of devices of that particular combination type. Thus, this embodiment results in increased efficiency of configuration.

In a further embodiment, the assembled input data includes (remote) control commands, and the method includes associating (remote) control codes interpretable by a specific CE device of the combination type with respective (remote) control commands prior to storing the assembled input data in the database. This speeds up the process of configuring the (remote) control system.

According to another aspect, the invention provides data processing system including a processor, memory and an external interface, and programmed to execute a method according to the invention. The data processing system may be part of the (remote) control system, but may alternatively be embedded in a device, be a personal computer, or be programmed to execute the method at a (remote) location in an implementation as, e.g., a web-server.

According to another aspect, the (remote) control system according to the invention is characterized in that the control system is configured to provide an external interface and to adapt the set-up process in accordance with information defining the combination of the further devices with basic features received through the external interface.

Thus, the (remote) control system needs to include only a database of basic further devices with their features, corresponding states and control commands. In terms of pre-defined device types, there are only a limited number of basic device types. These are well-known device-types with clear understanding of what it is. The system can combine the configuration information for different basic devices into a set of input data for configuring any one of a wide range of different combination device types. The interface for selecting a device type is kept simple, and storage of redundant data is avoided to a relatively large extent.

Preferably, the universal (remote) control system, includes a processor, memory and an external interface, and is programmed to execute a method according to the invention.

According to another aspect, the invention provides a computer program, configured, when loaded and executed in a computer, programmed computer network or other programmable apparatus, to implement a method according to the invention.

According to yet another aspect, the invention relates to a method of providing a service for assisting configuring a control architecture of a CE equipment. The expression “control architecture” refers to the topology of the equipment relevant to control of the equipment. The method comprises providing access to a database of multiple CE devices of a combination type. Each specific one of the combination type CE devices provides a specific combination of functionalities equivalent to that provided by a specific combination of respective further devices with respective features. The database has entries on, e.g., brand name and type of the combination type CE devices, commands codes (IR, RF, etc.). The method further comprises enabling to select a particular one of the combination type CE devices from the database for determining a control command for use on the CE equipment. In this manner the user of the CE equipment is provided with some assistance to configure his CE equipment so that at least part thereof can function as a combo-device.

### BRIEF DESCRIPTION OF THE DRAWING

The invention will now be explained in further detail by way of example and with reference to the accompanying drawing, wherein:

FIG. 1 shows an example of a home network architecture with a connection to the Internet, as an example of a setting for implementing the invention,

FIG. 2 is a schematic view of a universal remote control handset,

FIG. 3 shows in schematic fashion some components of a CE device of a combination type, and

FIG. 4 is flow diagram illustrating an embodiment of a method enabling a remote control system to be configured for controlling a device like the one shown in FIG. 3.

### DETAILED EMBODIMENTS

Nowadays, a plethora of new CE devices that combine features of existing devices are appearing on the market: A TV+VCR combination, TV+DVD combination, a home theatre comprising a DVD player+Amplifier+Tuner, etc. Many more new combinations will follow. In smart universal remote controls, it is becoming more difficult to offer a dedicated page for all these new combination devices integrating certain features or basic functionalities that used to be packaged in different products. The invention addresses a method for enabling a user to define his personal “combo-device” based on the basic functionalities. That is, the user can create his personal special home theatre device by specifying that this personal device comprises a DVD player, a VCR, an Amplifier & Tuner functionality and is controllable as if it were a single device. The invention addresses, among other things, the concept of a user-definable combo device. The user can define his personal combo-device by choosing a set of basic features to be cooperating in order to provide a user-desired functionality, or the system can propose a list of combo-devices given the devices or functionalities that the user has got available. The (remote) control device of the user can then be configured so as to facilitate user-interaction with the combo-device. For example, the combo-device is presented to the user as if it were a single physical device needing only a single command in order to turn on of off the power. As another example, the settings of the combo-device are presented for, e.g., being changed for personalization, as having only a few inputs and outputs.

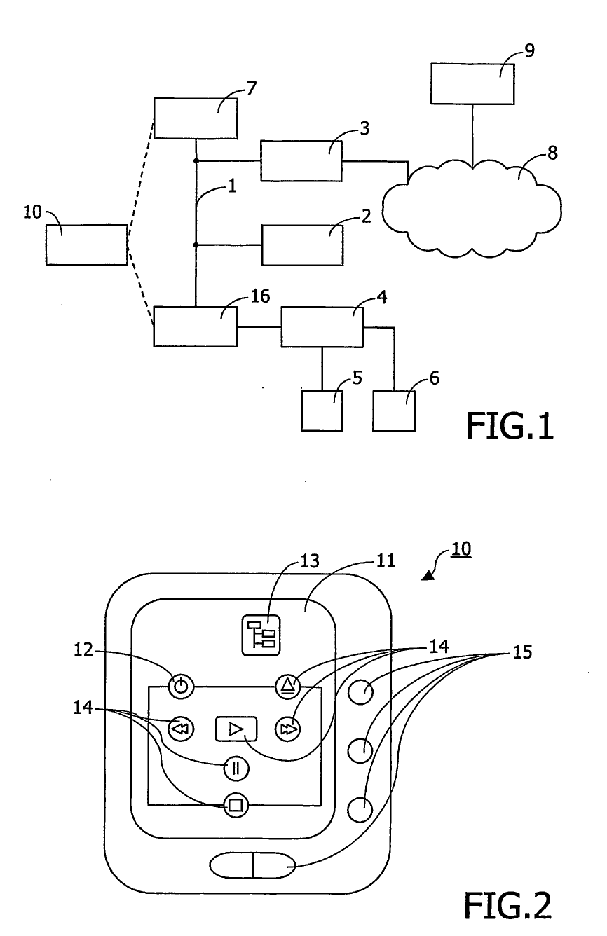

FIG. 1 is a diagram of CE devices connected to a home network 1. The illustrated example includes devices such as a television set 2, a personal computer (PC) 3, a lighting controller 4 that is connected to light dimmer 5 and curtain actuator 6, and a combination appliance 7. The PC 3 is connected to the Internet 8. Thus, it has access to a server 9 connected to the Internet 8. In the example, the combination appliance 7 is of a combination type providing a combination of functionalities equivalent to that provided by a combination of a (Digital Versatile Disk) DVD recorder and a radio receiver, as will be explained in more detail.

A remote control handset 10 in a universal remote control system is available to access the functionality (or functionalities) of each of the CE devices. Universal remote control systems as such are known. The term is used to denote any remote control capable of controlling a plurality of user selectable electronic appliances. The appropriate command codes may be pre-stored by the manufacturer and/or learned in a user-initiated learning mode. Dependent on the amount of memory, the universal remote control may be able to control only one electronic appliance at a time, or a plurality of appliances simultaneously without the need for intermediate learning of command codes. Hence, a learning remote control having storage capacity for command codes of only one electronic appliance is regarded as a universal remote control.

In the embodiment illustrated herein, the remote control handset 10 provides a graphical user interface. To this end, the remote control handset 10 preferably includes (FIG. 2) a touch screen 11. In FIG. 2, the screen view provided by the remote control handset 10 is appropriate to accessing the DVD playback functionality. It includes a plurality of ‘soft buttons’, including an on/off button 12, a menu button 13 and playback control buttons 14. The menu button 13 is useful for changing to a different screen view with other types of soft buttons, in order to access other aspects of the combination of functionalities provided by the combination appliance 7. Hard keys 15 are also provided as a means for entering user input.

Internal components of the remote control handset 10 (not shown in FIG. 2) include a processor, random access memory and a chip set with a graphics driver. Additionally, there is provided some form of non-volatile data storage, such as flash memory, or even a magnetic storage device. In the shown embodiment, the remote control handset 10 further includes an Infrared (IR) controller and Light Emitting Diode (LED), functioning as a transmitter of control signals carrying control codes encoding remote control commands. In other embodiments, the remote control handset 10 additionally or alternatively includes one or more radio-frequency (RF) wireless transmitters for transmitting control codes.

In the example shown in FIG. 1, a controller device 16 is equipped with an IR receiver (not shown), and arranged to translate the control codes into a format appropriate to a protocol used on the home network 1. The controller device 16 is thus part of the universal remote control system. In an alternative embodiment, the intelligence of the remote control system is included in the controller device 16, and the handset is merely used as input device. Indeed, the controller device 16 may be configured to provide a graphical user interface in co-operation with the television set 2, so that the universal remote control system is distributed over several devices.

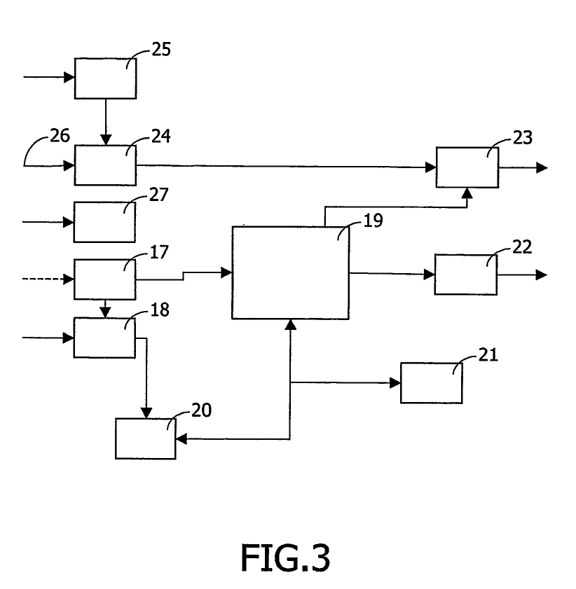

In the embodiment shown in FIG. 1, the universal remote control system is incorporated in the remote control handset 10 when used to control appropriately equipped CE devices, such as the combination appliance 7, directly. As shown in FIG. 3, the combination appliance 7 includes an IR interface 17 for receiving and interpreting control codes, which are passed on to a video decoder 18 and media processor 19. The media processor 19 is capable of routing video data to and from a Video Codec 20 and a DVD drive unit 21, as well as providing video data to a video encoder 22 for output to an external display device (not shown). Audio output is provided by a Digital-to-Analogue Converter (DAC) 23, which is alternatively fed with audio data obtained from a DVD or Analogue-to-Digital Converter (ADC) 24. ADC 24 receives input from an RF tuner 25 when the combination appliance 7 is used to receive a radio broadcast. It alternatively receives an input signal from an external audio input 26 when the combination appliance is used to record a DVD or CD. The illustrated combination appliance also includes a network adapter 27 for connection to the home network 1.

The combination appliance 7 thus provides a combination of functionalities equivalent to that provided by a combination of devices with respective basic features. This combination of basic devices includes a CD recorder, DVD recorder, CD player, DVD player, and radio tuner, amongst others. Note that certain combinations of physical components present in the combination appliance 7 form a virtual device equivalent to one of the basic devices listed above. The functionality or functionalities of a basic device can, for example in the case of the Video Codec 20 be included in the combination appliance 7 as hardware, as is illustrated herein, but also as software for execution by the media processor 19.

The IR interface 17 is suitable for receiving remote control commands, encoded as remote control codes carried by an infrared signal from the universal remote control handset 10. Thus, the combination of functionalities provided by the combination appliance 7 is made accessible to the user upon appropriate configuration of the remote control handset 10. Note that this distinguishes the combination appliance 7 from a ‘virtual’ combination appliance comprising a combination of devices with separate respective interfaces. In the latter case, the remote control handset 10 has to be configured to transmit separate remote control commands to each of the respective device interfaces. The combination appliance makes its functionality or functionalities accessible through a single interface, namely the IR interface 17 or, alternatively or additionally, through an interface to the home network 1. In practice, this means that the remote control handset 10 has to be programmed to control the combination appliance 7. In the case of a combination of separate, networked devices, the remote control handset 10 has to be programmed for controlling each device separately, whereupon macros are defined for controlling several of these devices in combination. This is set out more fully in WO 02/23802 (attorney docket US 000233 filed Sep. 14, 2000 as U.S. patent application Ser. No. 09/661,313 for Rik Sagar for INTERNET SERVICES FOR CONSUMER ELECTRONICS DEVICES, herein incorporated by reference in its entirety). In an advantageous variation on the method presented in the description of the current invention, the techniques of WO 02/23802 are used subsequent to configuration of the remote control handset 10, in order to define applications using particular combinations of functionalities equivalent to a sub-set of the basic devices to which the combination appliance 7 is equivalent. Further see, e.g., WO 01/54406 (attorney docket US 000014 filed Mar. 6, 2000 as U.S. patent application Ser. No. 09/519,546 for Erik Ekkel et al., for PERSONALIZING CE EQUIPMENT CONFIGURATION AT SERVER VIA WEB-ENABLED DEVICE, herein incorporated by reference in its entirety). WO 01/54406 discloses a technique for carrying out above techniques remotely, for example on the server 9, connected to the remote control handset 10 via the Internet 8, PC 3, home network 1 and controller device 16.

Above-mentioned WO02/23802 relates to a service application that surveys the functional elements available on a user's network, and surveys the availability of applications that may utilize combinations of these functional elements to achieve capabilities that are not realizable with individual devices. Each device on a user's network may have one or more functional elements that are available for use with functional elements of other devices on the user's network. The service application identifies applications that utilize a plurality of the functional elements on the user's network. The user has the option of selecting one or more of these applications for installation. The service application downloads the application, drivers, and other utility programs, as required, to one or more devices in the user's system, and configures the devices as required for operating with the application. Optionally, the service application identifies missing functional elements for available applications as well.

Above-mentioned WO01/54406 relates to facilitating the configuring of CE equipment by the consumer by means of delegating the configuring to an application server on the Internet. The consumer enters his/her preferences in a specific interactive Web page through a suitable user-interface of an Internet-enabled device, such as a PC or set-top box or digital cellphone. The application server generates the control data based on the preferences entered and downloads the control data to the CE equipment itself or to the Internet-enabled device.

Many CE devices operate as state machines. They change states in response to input from input from sensors, switches or timers. Even if the combination appliance 7 is not designed as a state machine, it can be modeled as such. The combination of basic devices to which the combination appliance 7 is equivalent, determines the possible operational states of the combination appliance 7. The remote control handset 10 is used to control transitions between possible states, so that the remote control handset 10 needs to be provided with information allowing it to carry out this task. This is done in a configuration process, based on input data retrieved from memory or provided by the user or an external device. At the end of the configuration process, appliance-related information is stored in the remote control system, including a description of the available settable states of the appliance and the control signals that must be sent to set the appliances in the respective appliance states. Also, limitations on the interactions between appliance states are stored in the remote control system. As part of the methods presented herein, the possible states of the combination appliance 7 are derived from the possible states of the basic devices to which it is equivalent, based on information defining the equivalent combination of devices. Techniques disclosed in US 2003/0106062 (attorney docket US 018140 filed May 12, 2001 as U.S. patent application Ser. No. 10/011,702 for Eugene Shteyn et al., for HOME NETWORK ENVIRONMENT AS A STATE MACHINE, herein incorporated by reference in its entirety) are advantageously employed to this end. US 2003/0106062 relates to controlling a home network as a super state machine consisting of a plurality of state machines of electronic consumer appliances attached to the home network. Setting the state of the home network results in setting the states of multiple appliances that are connected to the network. The system can automatically determine whether a particular network state would be reliable. For example, the system may present the user with a selection of reliable network states and the user can select a reliable network state that is meaningful to the user. The selected meaningful state may be stored or may be immediately implemented upon the user selection.

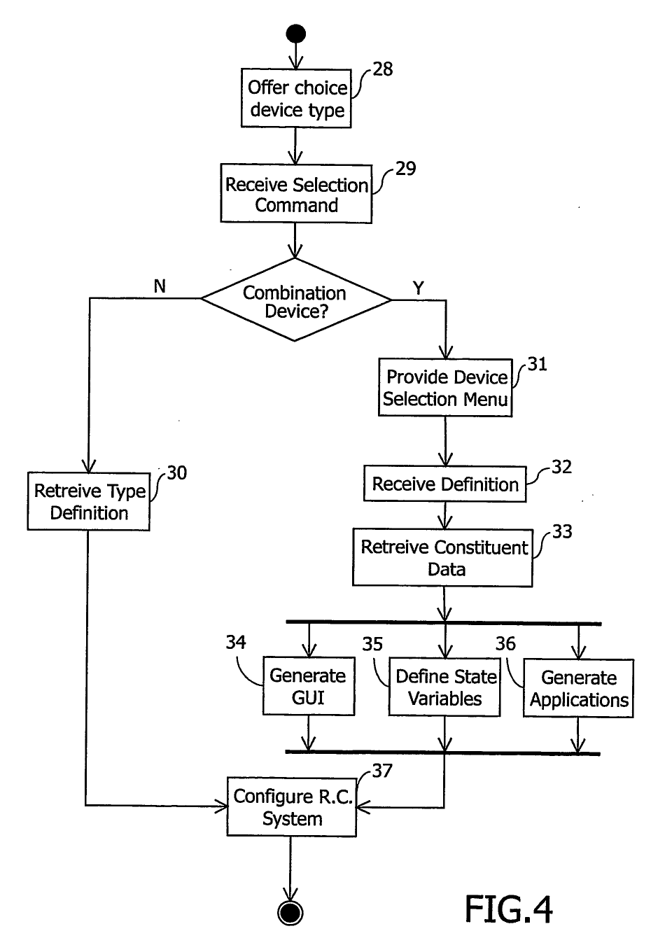

The configuration system discusses here has been scaled down to a limited number of pre-defined device types, including ‘basic device-types’. These are well-known device types with a clear understanding of what it is (TV, VCR, DVD, DVD recorder, HDD recorder, Amplifier, Tape, etc.). Another category are the ‘combination device types’, which include combinations of functionalities of the basic device types: Home Cinema, TV+VCR Combo, Receiver (Amplifier+Tuner), etc. In a first step 28 (FIG. 4), the system may offer some pre-defined combination devices (like the ones just mentioned), and the user may choose to define his personal combination device. In that case, the user informs the system that he has a ‘Home Cinema’ consisting of a DVD player, VCR, Tuner, Super CD player and Amplifier, for instance.

By providing this information, the system now can achieve three things: the system knows that for these devices certain IR codes will be shared (e.g., there will be only one power-off command); the system can generate a user interface by adding up the screens of the individual components and optionally there may be some smart logic subtracting those command buttons that are duplicates (such as power); and by knowing that certain devices physically belong in one device, the system will know that they share certain state variables. This is useful in case the system has some advanced features, based on tracking the state of equipment. That state information is used to conditionally send or not send commands. (For example, depending on the power state of a device, the power-on command is sent or not).

FIG. 4 gives an overview of an embodiment of a method enabling the universal remote control handset 10 to be configured to control transitions between possible states of the combination appliance 7. In the example, the input data for the configuration process is assembled by the remote control handset 10. However, in alternative embodiments the method is carried out on the PC 3, the server 9. That is to say, that configuration of the universal remote control handset 10 can be applied by executing an application embedded in the universal remote control handset 10, using a PC, or it can be done from a remote location (web-server).

Turning to FIG. 4, the user of the remote control handset 10 is offered a menu enabling him to choose one of a number of pre-defined device types or to select the option of defining a custom combination device type, in step 28. The pre-defined device types include ‘basic devices’, a well-known device type of which everyone agrees on what it is and which minimum set of features it should have. Examples include an amplifier, television set, videocassette recorder, etc. They advantageously also include pre-defined combination device types. For example, the vast majority of DVD players also offer the functionality of a CD player.

In a subsequent step 29 the user selects either one of the pre-defined device types or the custom combination device type. In the first case, the universal remote control handset 10 retrieves (step 30) a complete set of input data associated with the selected pre-defined device type from a data storage system, e.g., flash memory in the universal remote control handset. This input data is provided as input to the configuration process that completes the set-up of the universal remote control system.

In the alternative, if the custom combination device type is selected, such a set of input data is assembled by the remote control handset 10. To this end, the remote control handset 10 provides a menu for selecting basic devices (step 31). Thus, when the process is applied to the combination appliance 7, the user would tick off entries such as ‘DVD player’, ‘Radio tuner’, ‘Amplifier’, ‘CD recorder’, etc. The universal remote control handset 10 receives the definition in a further step 32. It then adapts the set-up process in accordance with the information received in that step 32.

In an alternative embodiment, the universal remote control handset 10 receives the definition of basic devices through another type of external interface. It may, for instance be configured to interrogate the combination appliance 7 over the home network 1. However, it is preferred to receive the information defining the combination of devices with basic features to which the combination appliance 7 is equivalent as user input through a user interface. This makes the universal remote control handset 10 more universal, in the sense that the device to be controlled need not conform to any mutually implemented standard or protocol.

In a next step 33, the information identifying the devices with basic features is used as a key to retrieve respective sets of data associated with the respective devices. These sets of data are the constituents of a complete set of data enabling the universal remote control handset to be set up to control the combination appliance. The universal remote control handset 10 preferably maintains such a database in memory.

Various uses of the constituent sets of data are illustrated in FIG. 4. In one step 34, the universal remote control handset 10 assembles data for generating a graphical user interface on the remote control system from data in the constituent sets retrieved in the preceding step 33. The retrieved data includes data defining a graphical user interface for accessing some of the functionalities of the respective associated device. As part of this step 34, the universal remote control handset 10 defines at least one screen view including elements defined in different ones of the constituent sets of data. For example, the data associated with a CD recorder may include a soft button to start recording, and the data associated with a tuner may include a soft button to select a pre-set frequency. The combined screen view would then include both buttons, to enable simple recording of a selected radio broadcast without having to switch screen views. In the example, both constituent sets of data would probably include a volume control button. As part of the step 34 of generating a graphical user interface, duplicate control buttons are subtracted from the definition of the screen view. The universal remote control handset 10 is able to detect functional features common to several basic devices but present only once in the combination device.

Preferably, the universal remote control handset 10 is configurable to track the state of the combination appliance 7 upon completion of the programming of the latter. In that case, the constituent data sets retrieved in the preceding step 33 advantageously include at least the definition of one or more state variables for tracking the state of the associated device with basic features. In the illustrated variant the universal remote control handset 10 is able to detect states of basic devices that are linked to the states of another basic device defined in the definition received in step 32. For example, the combination appliance 7 applies only one amplification level to the output of the DAC 23, regardless of whether the audio source is a DVD or a radio broadcast. Furthermore, selection of a DVD in the DVD drive unit 21 as audio source automatically means that the RF tuner 25 is disconnected. Thus, the states of the radio tuner and DVD player are linked. The universal remote control handset takes account of this by including only one state variable definition in the code for programming it to control the combination appliance 7. Information defining the consequences of the various possible values for the states of both basic devices is included.

In a further step 36, applications, or macros, employing the functionalities of several of the basic devices are generated, based on the received definition of the combination appliance 7. An example would be an application to record a radio broadcast on a DVD. Reference is made again to above-mentioned WO 02/23802, in particular, for further details of implementation.

As part of the final set-up, the configuration process includes a step 37, in which IR codes are associated with the various remote control commands that are defined in the assembled set of input data for the configuration process. Alternatively, or additionally, the universal remote control handset 10 will store the input data in a database. This allows the universal remote control handset 10 to be configured efficiently to control another instance of the custom combination device type, for example from a manufacturer using a different set of IR codes. Learning remote control codes is known per se in the context of universal remote control systems. One known technique includes downloading from a database, for example on the server 9 or PC 3. Another known technique involves the user of an Infrared receiver (not shown) on the universal remote control handset 10 to learn the relevant control codes from a remote control device originally supplied with the CE device. Using the present technique, the universal remote control device 10 is provided with input data informing it of the kinds and number of commands for which it must learn codes. When the codes are downloaded through the home network 2, the remote control handset 10 is informed of the composition of a sub-set of a complete set of manufacturer codes that is must download and store. For example, it need store the manufacturer's codes for controlling a DVD player, but not for controlling a tape recorder.

In summary, underlying the system described herein is the concept of having combination devices defined as a sum of their components, but also to allow for user-definable combination devices. Herein, a combination device is one box, or a set of mutually communicating boxes controllable through a common remote control interface, that combines a set of basic features. The user can define his personal combination devices by choosing a set of basic features or the system can propose a list of well-known combination devices.

When the user goes through a set-up procedure for a smart remote control (maybe on the device, or on another device like a PC), the user needs to add all CE devices he has in his house or room.

For each device, the user can choose from ‘basic device-types’ (TV, VCR, DVD-recorder, etc., or a ‘combination device-type).

When the set-up procedure is finished, the system (smart remote control) knows what CE devices the user has in his home.

This information can be used for intelligent remote control devices. For instance, the smart Remote Control needs to be able to know how certain device needs to be turned on. Knowing what kinds of functionalities are packed in one device helps the system to understand what to switch on and off.

For example, to record a DVD movie onto a VCR requires this information. If there is a separate DVD-player and a separate VCR, the user/system has to put both devices on, switch the VCR to the correct input, and start recording. If the user has one Home Cinema box with integrated DVD player and VCR, the user/system has only to turn that Home Cinema on, switch it to the correct input, and record.

Information about these combination devices may be put in a ‘database’ in the system. Such a database of all kinds of combination devices (including brand and IR-codes) may be built up that aid the user even more when setting this up.

The systems and method disclosed herein can be used in smart control systems (whether in one box or distributed over multiple devices) that use a universal database of control codes. The system may be used within the context of remote control (i.e., a control protocol using wireless communication of control commands from a device manipulated by the user or consumer of a CE apparatus) or within the context of wired control, or within the context allowing both communication modes.

The system can be applied both in universal remote control software and universal remote control databases.

The system can be applied irrespective of where the configuration of the universal remote control is performed: whether it is embedded in a device, whether it is done using a PC, or whether it is done from a remote location (web-server). As to the latter option, a service provider, for example, provides a service with a database that lists all kinds of practically useable combo-devices based on brand name, control codes, etc., that assists the user when setting up his home network system.

The examples described above relate to IR commands but it is clear that a similar approach is also applicable to RF commands, a combination of IR and RF commands or any other type of wireless or wired command protocol.

Some of the examples above describe CE equipment including audio-video processing devices and equipment. It is noted that CE equipment may also include devices such as apparatus to control the opening or closing of curtains, blinds or sunshades, apparatus to control lighting, in-house climate, etc. Some of these may have a very simple control architecture limited to power on/off or toggling between two states. These apparatus may be integrated in, e.g., a home theater so that, when the home theater combo-device is activated, the curtains are drawn and lighting is dimmed automatically.

It should be noted that the above-mentioned embodiments illustrate, rather than limit, the invention, and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The mere fact that certain measures are recited in mutually different dependent claims does not indicate that a combination of these measures cannot be used to advantage.

1. Method of enabling to program a control system (10) for controlling a CE device (7) of a combination type providing a combination of functionalities equivalent to that provided by a further combination of respective further devices with respective features, the CE device including an interface (17;27) for receiving a control signal to access the combination of functionalities, wherein the combination of functionalities determines possible operational states of the CE device (7), which method includes providing input data for a configuration process for generating program code enabling the control system (10) to determine a control signal controlling a transition between relevant ones of the possible states, characterized in that the input data is assembled by a data processing system (3;9;10) in accordance with information defining the further combination of the respective further devices with the respective features received through an interface to the data processing system (3;9;10).

2. Method according to claim 1, including receiving a command selecting one of a custom combination device type and at least one pre-defined device type, wherein the input data is assembled upon receiving a command selecting the custom combination device type, wherein, if a pre-defined device type is selected, a complete set of input data associated with the selected pre-defined device type is retrieved from a data storage system and provided as input data for the configuration process.

3. Method according to claim 1, wherein the input data for the configuration process includes a set of control commands for association with control codes in a format interpretable by the CE device, wherein, in the step of assembling the input data, a control command directed at a specific one of the features included in a plurality of the respective further devices in the defined combination is included in the set of control commands only once.

4. Method according to claim 1, wherein the input data includes at least a definition of a state variable for tracking the state of the CE device (7), wherein, in the step of assembling the input data, at least one state variable is included corresponding to a state variable for tracking the state of a specific one of the respective further devices with basic features in the defined combination, wherein, upon determining that a state of a feature in a first of the respective further devices in the defined combination is linked to a state of a feature in at least another of the respective further devices in the defined combination, only one corresponding state variable is included in the input data.

5. Method according to claim 1, including assembling data for generating a graphical user interface on the control system (10) from respective constituent sets of data defining a graphical user interface for each of a plurality of the respective further devices in the defined combination, wherein at least one screen view is defined in the assembled data including elements (12-14) defined in different ones of constituent sets of data.

6. Method according to claim 5, wherein duplicate elements (12-14) in the constituent sets of data are subtracted from the defined screen view.

7. Method according to claim 1, wherein the information defining the combination of the respective further devices with respective basic features is received as user input through a user interface.

8. Method according to claim 1, wherein the assembled input data is added as an entry into a database.

9. Method according to claim 1, wherein the assembled input data includes control commands, wherein the method includes associating control codes interpretable by the CE device (7) of the combination type with respective control commands prior to storing the assembled input data in the database.

10. Data processing system including a processor, memory and an external interface, and programmed to execute a method according to claim 1.

11. Control system for controlling a CE device (7) of a combination type providing a combination of functionalities equivalent to that provided by a further combination of respective further devices with respective features, the CE device (7) including an interface (17;27) for receiving a control signal to access the combination of functionalities, wherein the combination of functionalities determines possible operational states of the CE device (7), which control system (10) is configured to run a set-up process for configuring the control system to determine a control signal controlling a transition between relevant ones of the possible states, characterized in that the control system is configured to provide an external interface and to adapt the set-up process in accordance with information defining the further combination of the respective further devices with features received through the external interface.

12. Control system, including a processor, memory and an external interface, and programmed to execute a method according to claim 1.

13. Computer program, adapted, when loaded and executed in a computer, programmed computer network of other programmable apparatus, to put into force a method according to claim 1.

14. A method of providing a service for assisting configuring a control architecture of a CE equipment, the method comprising providing access to a database of multiple CE devices (7) of a combination of functionalities equivalent to that provided by a specific combination of respective further devices with respective features, the method further comprising enabling to select a particular one of the CE devices for determining a control command for use of the CE equipment.
